(19) United States
(12) Patent Application Publication
(10) Pub. No.: US 2026/0122630 A1
(43) Pub. Date: Apr. 30, 2026

(54) SEMI-PERSISTENTLY SCHEDULED DOWNLINK CONTROL MESSAGES

(71) Applicant: QUALCOMM Incorporated, San Diego, CA (US)

(72) Inventors: Gabi SARKIS, San Diego, CA (US); Diana MAAMARI, San Diego, CA (US)

(21) Appl. No.: 18/930,693

(22) Filed: Oct. 29, 2024

(51) Int. Cl. H04W 72/11; H04L 1/00; H04W 72/231

(52) U.S. Cl. CPC H04W 72/11; H04L 1/0004; H04L 1/0061; H04W 72/231

(57) ABSTRACT

Methods, systems, and devices for wireless communications are described. A network entity may configure a user equipment (UE) with semi-persistently scheduled control messages. A UE may receive a first control message indicating a configuration including first parameters associated with semi-persistently scheduled downlink control messages including scheduling information for downlink data messages. The UE may receive a second control message activating monitoring for the semi-persistently scheduled downlink control messages. The second control message may include second parameters associated with the semi-persistently scheduled downlink control messages. The UE may monitor for a downlink data message based on the first parameters, the second parameters, third parameters from a downlink control message of the semi-persistently scheduled downlink control messages, or any combination thereof.

### FIELD OF TECHNOLOGY

The following relates to wireless communications, including semi-persistently scheduled downlink control messages.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE). Wireless communications devices may semi-persistently schedule transmissions.

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving a first control message indicating a configuration including one or more first parameters associated with semi-persistently scheduled downlink control messages, where the semi-persistently scheduled downlink control messages includes scheduling information for one or more downlink data messages, receiving a second control message activating monitoring for the semi-persistently scheduled downlink control messages, the second control message including one or more second parameters associated with the semi-persistently scheduled downlink control messages, and monitoring for a downlink data message based on the one or more first parameters, the one or more second parameters, one or more third parameters from a downlink control message of the semi-persistently scheduled downlink control messages, or any combination thereof.

A UE for wireless communications is described. The UE may include one or more memories storing processor executable code, and one or more processors coupled with the one or more memories. The one or more processors may individually or collectively be operable to execute the code to cause the UE to receive a first control message indicating a configuration including one or more first parameters associated with semi-persistently scheduled downlink control messages, where the semi-persistently scheduled downlink control messages includes scheduling information for one or more downlink data messages, receive a second control message activating monitoring for the semi-persistently scheduled downlink control messages, the second control message including one or more second parameters associated with the semi-persistently scheduled downlink control messages, and monitor for a downlink data message based on the one or more first parameters, the one or more second parameters, one or more third parameters from a downlink control message of the semi-persistently scheduled downlink control messages, or any combination thereof.

Another UE for wireless communications is described. The UE may include means for receiving a first control message indicating a configuration including one or more first parameters associated with semi-persistently scheduled downlink control messages, where the semi-persistently scheduled downlink control messages includes scheduling information for one or more downlink data messages, means for receiving a second control message activating monitoring for the semi-persistently scheduled downlink control messages, the second control message including one or more second parameters associated with the semi-persistently scheduled downlink control messages, and means for monitoring for a downlink data message based on the one or more first parameters, the one or more second parameters, one or more third parameters from a downlink control message of the semi-persistently scheduled downlink control messages, or any combination thereof.

A non-transitory computer-readable medium storing code for wireless communications is described. The code may include instructions executable by one or more processors to receive a first control message indicating a configuration including one or more first parameters associated with semi-persistently scheduled downlink control messages, where the semi-persistently scheduled downlink control messages includes scheduling information for one or more downlink data messages, receive a second control message activating monitoring for the semi-persistently scheduled downlink control messages, the second control message including one or more second parameters associated with the semi-persistently scheduled downlink control messages, and monitor for a downlink data message based on the one or more first parameters, the one or more second parameters, one or more third parameters from a downlink control message of the semi-persistently scheduled downlink control messages, or any combination thereof.

Some examples of the method, UEs, and non-transitory computer-readable medium described herein may further include operations, features, means, or instructions for receiving the downlink control message of the semi-persistently scheduled downlink control messages based on the one or more first parameters, the one or more second parameters, or both, where the downlink control message includes the one or more third parameters associated with reception of the downlink data message.

In some examples of the method, UEs, and non-transitory computer-readable medium described herein, the one or more third parameters include one or more fields that indicate one or more reception occasions to be skipped.

Some examples of the method, UEs, and non-transitory computer-readable medium described herein may further include operations, features, means, or instructions for monitoring for the downlink control message of the semi-persistently scheduled downlink control messages and refraining from monitoring for the downlink data message based on failing to receive the downlink control message.

Some examples of the method, UEs, and non-transitory computer-readable medium described herein may further include operations, features, means, or instructions for monitoring for the downlink control message of the semi-persistently scheduled downlink control messages in a control resource set (CORESET), a search space, or both.

Some examples of the method, UEs, and non-transitory computer-readable medium described herein may further include operations, features, means, or instructions for monitoring for the downlink control message of the semi-persistently scheduled downlink control messages in a first control region that may be different from a second control region in which the first control message may be received.

Some examples of the method, UEs, and non-transitory computer-readable medium described herein may further include operations, features, means, or instructions for monitoring for the downlink control message of the semi-persistently scheduled downlink control messages in one or more time-frequency resources, where the one or more first parameters, the one or more second parameters, or both include the one or more time-frequency resources.

Some examples of the method, UEs, and non-transitory computer-readable medium described herein may further include operations, features, means, or instructions for performing a blind decoding procedure in one or more candidate locations for the downlink control message of the semi-persistently scheduled downlink control messages, where the one or more candidate locations may be in accordance with the one or more first parameters, the one or more second parameters, or both.

In some examples of the method, UEs, and non-transitory computer-readable medium described herein, the one or more first parameters, the one or more second parameters, or both include one or more frequency resources, one or more time resources, a control region configuration or a control region index, a search space configuration or a search space index, one or more candidate locations, a control message format, or any combination thereof that may be associated with the semi-persistently scheduled downlink control messages.

In some examples of the method, UEs, and non-transitory computer-readable medium described herein, the one or more third parameters of the downlink control message include a slot offset, a frequency domain allocation, a time domain allocation, a modulation and coding scheme (MCS), or any combination thereof associated with the downlink data message.

In some examples of the method, UEs, and non-transitory computer-readable medium described herein, a first cyclic redundancy check (CRC) of the downlink control message may be the same as or smaller than a second CRC of the second control message.

Some examples of the method, UEs, and non-transitory computer-readable medium described herein may further include operations, features, means, or instructions for monitoring for the downlink control message of the semi-persistently scheduled downlink control messages and monitoring for the downlink data message based on the one or more first parameters, the one or more second parameters, or both based on failing to receive the downlink control message.

In some examples of the method, UEs, and non-transitory computer-readable medium described herein, the first control message includes a radio resource control (RRC) message, the second control message includes a downlink control information (DCI) message, a medium access control (MAC)-control element (CE) message, or an RRC message, and the downlink control message includes a DCI message.

In some examples of the method, UEs, and non-transitory computer-readable medium described herein, the one or more downlink data messages satisfy a threshold level of variation in packet size, may have jitter, or both and the first control message may be received in accordance with the threshold level of variation in packet size, the jitter, or both.

A method for wireless communications by a network entity is described. The method may include outputting a first control message indicating a configuration including one or more first parameters associated with semi-persistently scheduled downlink control messages, where the semi-persistently scheduled downlink control messages includes scheduling information for one or more downlink data messages, outputting a second control message activating monitoring for the semi-persistently scheduled downlink control messages, the second control message including one or more second parameters associated with the semi-persistently scheduled downlink control messages, and outputting for a downlink data message based on the one or more first parameters, the one or more second parameters, one or more third parameters from a downlink control message of the semi-persistently scheduled downlink control messages, or any combination thereof.

A network entity for wireless communications is described. The network entity may include one or more memories storing processor executable code, and one or more processors coupled with the one or more memories. The one or more processors may individually or collectively be operable to execute the code to cause the network entity to output a first control message indicating a configuration including one or more first parameters associated with semi-persistently scheduled downlink control messages, where the semi-persistently scheduled downlink control messages includes scheduling information for one or more downlink data messages, output a second control message activating monitoring for the semi-persistently scheduled downlink control messages, the second control message including one or more second parameters associated with the semi-persistently scheduled downlink control messages, and output for a downlink data message based on the one or more first parameters, the one or more second parameters, one or more third parameters from a downlink control message of the semi-persistently scheduled downlink control messages, or any combination thereof.

Another network entity for wireless communications is described. The network entity may include means for outputting a first control message indicating a configuration including one or more first parameters associated with semi-persistently scheduled downlink control messages, where the semi-persistently scheduled downlink control messages includes scheduling information for one or more downlink data messages, means for outputting a second control message activating monitoring for the semi-persistently scheduled downlink control messages, the second control message including one or more second parameters associated with the semi-persistently scheduled downlink control messages, and means for outputting for a downlink data message based on the one or more first parameters, the one or more second parameters, one or more third parameters from a downlink control message of the semi-persistently scheduled downlink control messages, or any combination thereof.

A non-transitory computer-readable medium storing code for wireless communications is described. The code may include instructions executable by one or more processors to output a first control message indicating a configuration including one or more first parameters associated with semi-persistently scheduled downlink control messages, where the semi-persistently scheduled downlink control messages includes scheduling information for one or more downlink data messages, output a second control message activating monitoring for the semi-persistently scheduled downlink control messages, the second control message including one or more second parameters associated with the semi-persistently scheduled downlink control messages, and output for a downlink data message based on the one or more first parameters, the one or more second parameters, one or more third parameters from a downlink control message of the semi-persistently scheduled downlink control messages, or any combination thereof.

Some examples of the method, network entities, and non-transitory computer-readable medium described herein may further include operations, features, means, or instructions for outputting the downlink control message of the semi-persistently scheduled downlink control messages based on the one or more first parameters, the one or more second parameters, or both, where the downlink control message includes the one or more third parameters associated with reception of the downlink data message.

In some examples of the method, network entities, and non-transitory computer-readable medium described herein, the downlink control message may be output in a CORESET, a search space, or both.

In some examples of the method, network entities, and non-transitory computer-readable medium described herein, the downlink control message may be output in a first control region that may be different from a second control region in which the first control message may be received.

In some examples of the method, network entities, and non-transitory computer-readable medium described herein, the downlink control message may be output via one or more time-frequency resources and the one or more first parameters, the one or more second parameters, or both include the one or more time-frequency resources.

In some examples of the method, network entities, and non-transitory computer-readable medium described herein, the one or more first parameters, the one or more second parameters, or both include one or more frequency resources, one or more time resources, a control region configuration or a control region index, a search space configuration or a search space index, one or more candidate locations, a control message format, or any combination thereof that may be associated with the semi-persistently scheduled downlink control messages.

In some examples of the method, network entities, and non-transitory computer-readable medium described herein, the one or more third parameters of the downlink control message include a slot offset, a frequency domain allocation, a time domain allocation, a MCS, or any combination thereof associated with the downlink data message.

In some examples of the method, network entities, and non-transitory computer-readable medium described herein, a first CRC of the downlink control message may be the same as or smaller than a second CRC of the second control message.

In some examples of the method, network entities, and non-transitory computer-readable medium described herein, the first control message includes an RRC message, the second control message includes a DCI message, a MAC-CE message, or an RRC message, and the downlink control message includes a DCI message.

In some examples of the method, network entities, and non-transitory computer-readable medium described herein, the one or more downlink data messages satisfy a threshold level of variation in packet size, may have jitter, or both and the first control message may be received in accordance with the threshold level of variation in packet size, the jitter, or both.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIGS. 1 and 2 show examples of wireless communications systems that support semi-persistently scheduled downlink control messages in accordance with one or more aspects of the present disclosure.

FIG. 3 shows an example of a process flow that supports semi-persistently scheduled downlink control messages in accordance with one or more aspects of the present disclosure.

FIGS. 4 and 5 show block diagrams of devices that support semi-persistently scheduled downlink control messages in accordance with one or more aspects of the present disclosure.

FIG. 6 shows a block diagram of a communications manager that supports semi-persistently scheduled downlink control messages in accordance with one or more aspects of the present disclosure.

FIG. 7 shows a diagram of a system including a device that supports semi-persistently scheduled downlink control messages in accordance with one or more aspects of the present disclosure.

FIGS. 8 and 9 show block diagrams of devices that support semi-persistently scheduled downlink control messages in accordance with one or more aspects of the present disclosure.

FIG. 10 shows a block diagram of a communications manager that supports semi-persistently scheduled downlink control messages in accordance with one or more aspects of the present disclosure.

FIG. 11 shows a diagram of a system including a device that supports semi-persistently scheduled downlink control messages in accordance with one or more aspects of the present disclosure.

FIGS. 12 through 15 show flowcharts illustrating methods that support semi-persistently scheduled downlink control messages in accordance with one or more aspects of the present disclosure.

### DETAILED DESCRIPTION

In some wireless communications systems, a network entity may semi-persistently schedule periodic data reception, transmission, or both. The network entity may schedule downlink data transmissions (e.g., physical downlink shared channel (PDSCH) transmissions) using downlink semi-persistently scheduling and schedule uplink data transmissions (e.g., physical uplink shared channel (PUSCH) transmissions) using configured uplink grants. Some parameters associated with semi-persistently scheduled data may be configured using semi-static control signaling, such as via radio resource control (RRC) signaling. Additionally, the semi-persistently scheduled transmissions may be activated and deactivated via dynamic control signaling, such as via downlink control information (DCI) signaling. The dynamic control signaling may include scheduling parameters, which may be consistent across multiple occasions. For example, a DCI may activate semi-persistently scheduled data, where each occasion of the semi-persistently scheduled data has a same time and a same frequency allocation. However, in some implementations, a packet size of periodic data may vary or jitter in packet arrival time may occur, and a constant time and frequency allocation across multiple data occasions may not provide adequate resources. Examples of implementations in which the packet size of periodic data may vary or jitter in packet arrival time may occur include extended reality (XR) applications.

As described herein, to reduce overhead while supporting the variation in packet size, control messages may be scheduled semi-persistently. That is, in examples in which packet sizes of periodic data traffic are variable, control messages may be scheduled semi-persistently rather than or in addition to data messages. For example, a network entity may indicate parameters associated with semi-persistently scheduled control messages, such as a configuration for semi-persistently scheduled control messages. A dynamic control message may activate the semi-persistently scheduled control messages. Each semi-persistently scheduled control message may indicate time and frequency resources for a corresponding data message. By semi-persistently scheduling the control messages rather than data transmissions, the control messages may flexibly allocate time and frequency resources for data packets of variable sizes.

Aspects of the disclosure are initially described in the context of wireless communications systems. Aspects of the disclosure are also described in the context of process flows. Aspects of the disclosure are further illustrated by and described with reference to apparatus diagrams, system diagrams, and flowcharts that relate to semi-persistently scheduled downlink control messages.

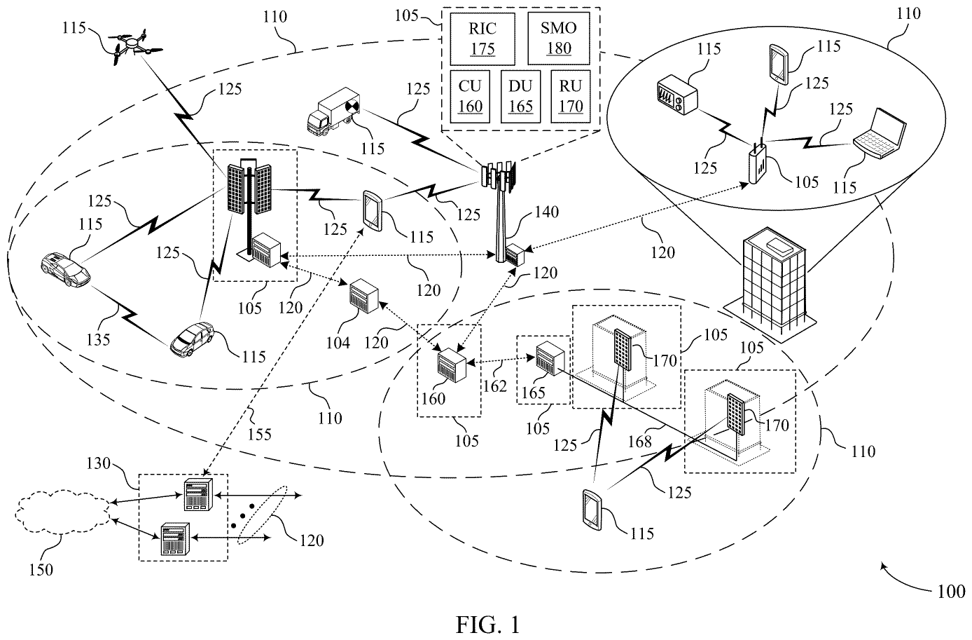

FIG. 1 shows an example of a wireless communications system 100 that supports semi-persistently scheduled downlink control messages in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., RRC, service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support semi-persistently scheduled downlink control messages as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some cases, the network entity 105 and the UE 115 may reduce control overhead by implementing semi-persistent scheduling. For example, the network entity 105, the UE 115, or both may receive or transmit data periodically without a grant at each data occasion. In a downlink scenario for example, the UE 115 may receive downlink data (e.g., PDSCH) periodically without a grant for every downlink data transmission or message. In such examples, the UE 115 may receive a first control message (e.g., RRC) including a configuration for some parameters associated with semi-persistently scheduled downlink data transmissions. A second control message (e.g., DCI) may subsequently activate the configuration. The first control message and the second control message may include information about time and frequency resources of the semi-persistently scheduled downlink data transmissions, such as frequency domain allocations, time domain allocations, offsets, or the like. However, the time and frequency resources being applicable to all of the semi-persistently scheduled downlink data transmissions may be limiting in some cases.

In some implementations, periodic data transmissions may have variable size (e.g., frequency, time, or both). For example, in a downlink video scenario, video packets may vary in size because of compression, jitter, or both. Accordingly, semi-persistently scheduling the data transmissions may not be applicable to scenarios in which packet size varies (e.g., beyond a threshold variability, such as in the case of video or other applications not having a fixed bit rate).

As described herein, to reduce overhead while supporting the variation in packet size, control messages may be scheduled semi-persistently. For example, a network entity 105 and a UE 115 may exchange control messages configuring parameters associated with and activating semi-persistently scheduled control messages. That is, a first control message may configure the semi-persistently scheduled control messages and a second control message may activate the semi-persistently scheduled control messages. Each control message of the semi-persistently scheduled control message may include parameters about a data reception, such as information about time and frequency resources for a data reception. By semi-persistently scheduling the control messages rather than data transmissions, the control messages may allocate time and frequency resources for data packets of variable sizes.

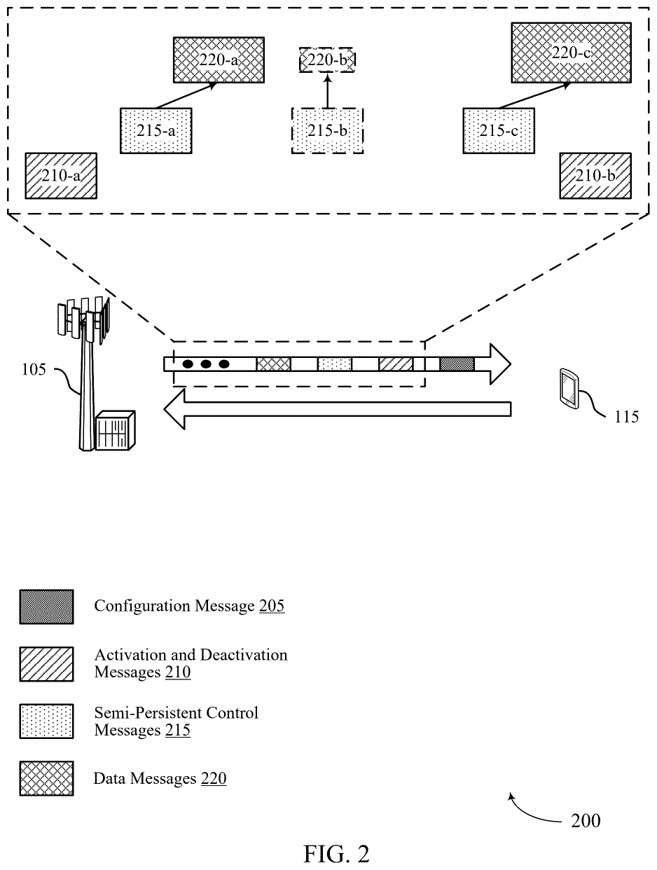

FIG. 2 shows an example of a wireless communications system 200 that supports semi-persistently scheduled downlink control messages in accordance with one or more aspects of the present disclosure. The wireless communications system 200 may implement aspects of wireless communications system 100. For example, the wireless communications system 200 may include a UE 115 and a network entity 105, which may be examples of the corresponding devices described with reference to FIG. 1.

The network entity 105 and the UE 115 may reduce overhead and support variability in data packet size by implementing semi-persistently scheduled downlink control messages. For example, the network entity 105 may output a configuration message 205 (e.g., an RRC configuration message) including parameters associated with semi-persistent control messages 215. The network entity 105 may output activation and deactivation messages 210 activating and deactivating the semi-persistent control messages 215. The activation and deactivation messages 210 may be DCI messages, MAC-control element (CE) messages, or RRC messages.

In the example of FIG. 2, the network entity 105 may output, and the UE 115 may receive, an activation message 210-a that activates the semi-persistent control messages 215. That is, after communication of the activation message 210-a, the network entity 105 and the UE 115 may communicate the semi-persistent control messages 215 periodically. In other words, the semi-persistent control messages 215 may occur on a semi-persistent or periodic basis after activation by the activation message 210-a and until deactivation by a deactivation message 210-b (e.g., transmitted when the process is active).

The semi-persistent control messages 215 may include parameters about the data messages 220. For example, each respective semi-persistent control message may indicate frequency domain information, time domain information, or both about an associated data message. As an example, a semi-persistent control message 215-a may include information about a data message 220-a, a semi-persistent control message 215-b may include information about a data message 220-b, and a semi-persistent control message 215-c may include information about a data message 220-c.

The UE 115 may monitor for the semi-persistent control messages 215. For example, the UE 115 may monitor for the semi-persistent control messages 215 according to the configuration message 205, the activation message 210-a, or both. The semi-persistent control messages 215 may be in a control region (e.g., a CORESET, such as a normal control region), a search space, or both. The control region may include a frequency (e.g., a bandwidth), a duration (e.g., a quantity of symbols), or both. In other words, the UE 115 may be configured with a CORESET associated with receipt of control messages (e.g., including the semi-persistent control messages 215), where the CORESET includes a frequency and duration.

In some examples, the semi-persistent control messages 215 may be in a region that is not monitored according to a search space configuration. That is, the semi-persistent control messages 215 may be in a symbol or slot that is outside of the search space (e.g., configured at the UE 115). For example, the semi-persistent control messages 215 may be received by the UE 115 in a symbol that is after a quantity of symbols indicated by the CORESET. Alternatively, the semi-persistent control messages 215 may be in an indicated slot (e.g., indicated by the configuration message 205, the activation message 210-a, or both). The UE 115 may not have monitored for downlink messages in the slot without an indication by the configuration message 205, the activation message 210-a, or both (e.g., without indication by the network entity 105 to monitor).

In some other examples, the semi-persistent control messages 215 may be in a separate control region. As an example, the UE 115 may receive the configuration message 205, the activation message 210-a, or both in a first CORESET and the semi-persistent control messages 215 in a second CORESET (e.g., different than and separate from the first CORESET). Alternatively, the UE 115 may receive the semi-persistent control messages 215 in indicated time-frequency resources. For example, the configuration message 205, the activation message 210-a, or both may include an indication of time-frequency resources, such as an indication of one or more physical resource blocks and one or more symbols.

The UE 115 may receive the semi-persistent control messages 215 without performing blind search or decoding. That is, the UE 115 may monitor for the semi-persistent control messages 215 in a specified location according to the configuration message 205, the activation message 210-a, or both (e.g., explicitly configured location and format). Alternatively, the UE 115 may perform blind decoding to receive the semi-persistent control messages 215. For example, the UE 115 may perform blind decoding at one or more candidate locations, search hypothesis, or both.

The configuration message 205 and the activation message 210-a may include different parameters related to the semi-persistent control messages 215 that the UE 115 may use to perform monitoring. For example, the parameters may include frequency resources to receive the semi-persistent control messages 215 (e.g., a starting location, such as a CCE, or a starting location and duration, such as an frequency domain resource allocation (FDRA)), time resources to receive the semi-persistent control messages 215, a control region configuration or index (e.g., a CORESET index) to search for the semi-persistent control messages 215 in, a search space configuration or index, one or more candidates to monitor, a control message format (e.g., a DCI format), or any combination thereof. In some examples, the configuration message 205 may include a periodicity of the semi-persistent control messages 215 while the activation message 210-a may include the frequency resource, time resource, and monitoring information. The activation message 210-a may include one or more fields corresponding to respective parameters. As an example, the activation message 210-a may include one or more fields indicative of resources (e.g., time, frequency, or both), monitoring information (e.g., indices for CORESETs, search spaces, etc.), or the like.

The network entity 105 may transmit, and the UE 115 may receive, the data messages 220 according to parameters included in the configuration message 205, the activation message 210-a, the semi-persistent control messages 215, or any combination thereof. For example, the network entity 105 may include parameters for reception of the data messages 220 at the UE 115 in control messages prior to the semi-persistent control messages 215 (e.g., in the configuration message 205 and the activation message 210-a) to reduce a size of the semi-persistent control messages 215. As an example, the network entity 105 may include parameters that are applicable to each of the data messages 220, while the semi-persistent control messages 215 may include information specific to an associated data message.

The parameters may include a slot offset, a frequency domain allocation, a time domain allocation, a modulation and coding scheme (MCS), a quantity of layers, or the like. The parameters may support variability of the data messages 220 in accordance with jitter and changes in packet size. For example, the slot offset may indicate when packet reception is to occur to accommodate jitter (e.g., variability in arrival time of packets). The frequency domain allocation, the time domain allocation, and the MCS may support adjustment of different types of resource allocations in response to changes in packet size (e.g., between respective data messages 220).

In some examples, the UE 115 may use a smaller cyclic redundancy check (CRC) for the semi-persistent control messages 215 compared to the configuration message 205, the activation and deactivation messages 210, or both. For example, because the semi-persistent control messages 215 are scheduled and have fewer or no search hypothesis compared to the other control messages, the UE 115 may reduce the CRC size. That is, the UE 115 may perform a CRC using a smaller quantity of bits (e.g., fewer bits) for the semi-persistent control messages 215 compared to the configuration message 205, the activation and deactivation messages 210, or both. Alternatively, the UE 115 may perform the CRC using a same quantity of bits (e.g., a same CRC size) for the semi-persistent control messages 215 and the configuration message 205, the activation and deactivation messages 210, or both.

The network entity 105 may indicate that one or more reception occasions for the data messages 220 are skipped. For example, the network entity 105 may indicate that one or more reception occasions are skipped via explicit or implicit indications in the semi-persistent control messages 215. As an example, the semi-persistent control message 215-b may indicate that a reception occasion corresponding to the data message 220-b is skipped (e.g., that there is no payload or content for the data message 220-b, that the data message 220-b will not be transmitted, etc.). The semi-persistent control message 215-b may include an explicit indication that the data message 220-b (e.g., and one or more subsequent data messages) is skipped via a field, a special value in a field, or a combination of multiple field values. Alternatively, the network entity 105 may implicitly indicate that the reception occasion corresponding to the semi-persistent control message 215-b or the data message 220-b is skipped by refraining from transmitting the semi-persistent control message 215-b. That is, an absence of the semi-persistent control message 215-b in the expected occasion (e.g., according to the parameters included in the configuration message, the activation message 210-a, or both) may indicate that a reception occasion associated with the semi-persistent control message 215-b will not include communication of a data message (e.g., reception is skipped). The UE 115 may not search for (e.g., may refrain from monitoring for) the data message 220-b based on the explicit or implicit indication of the reception occasion being skipped.

In some examples, the absence of the semi-persistent control message 215-b may indicate that the UE 115 is to apply parameters for reception of the data message 220-b based on previously received control messages. That is, absence of the semi-persistent control message 215-b associated with the data message 220-b may indicate that the data message 220-b is to be received using parameters configured via the configuration message 205, parameters indicated in the activation message 210-a, or both. In other words, the network entity 105 may refrain from transmitting the semi-persistent control message 215-b in examples in which the associated data message (e.g., the data message 220-b in this example) is capable of being received according to previously indicated parameters (e.g., according to default parameters). In such examples, the network entity 105 may transmit the semi-persistent control message 215-b to override the previously indicated parameters (e.g., when the data message requires resources that are varied beyond a threshold with the previously indicated parameters).

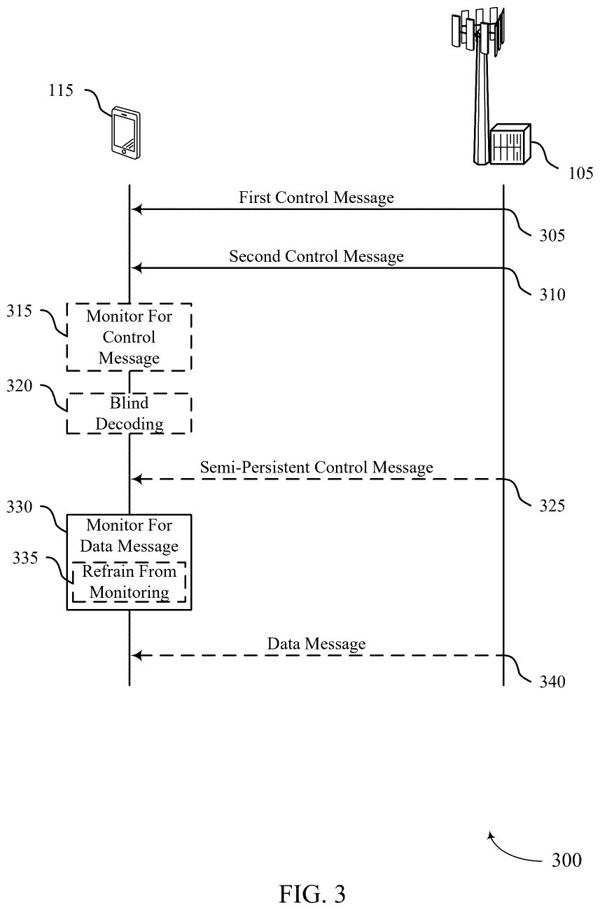

FIG. 3 shows an example of a process flow 300 that supports semi-persistently scheduled downlink control messages in accordance with one or more aspects of the present disclosure. The process flow 300 may implement or be implemented by aspects of the wireless communications system 100, the wireless communications system 200, or both. For example, the process flow 300 may include a UE 115 and a network entity 105, which may be examples of corresponding devices as described with reference to FIGS. 1 and 2.

Alternative examples of the following may be implemented, where some operations are performed in a different order than described or are not performed at all. In some examples, operations may include additional features not mentioned below, or further operations may be added. Although the UE 115 and the network entity 105 are shown performing the operations of the process flow 300, some aspects of some operations may also be performed by one or more other wireless devices.

At 305, the network entity 105 may output, or the UE 115 may receive, a first control message. For example, the UE 115 may receive a first control message indicating a configuration including one or more first parameters associated with semi-persistently scheduled downlink control messages. The semi-persistently scheduled downlink control messages may include scheduling information for one or more downlink data messages. In some examples, the first control message may be an example of an RRC message or the configuration message 205 as described with reference to FIG. 2.

At 310, the network entity 105 may output, or the UE 115 may receive, a second control message. For example, the UE 115 may receive a second control message activating monitoring for the semi-persistently scheduled downlink control messages, the second control message including one or more second parameters associated with the semi-persistently scheduled downlink control messages. The second control message may be an example of a DCI, a MAC-CE, or an RRC message. Additionally, or alternatively, the second control message may be an example of the activation message 210-a as described with reference to FIG. 2.

The first control message and the second control message may indicate the first and second parameters that the UE 115 may use to receive the semi-persistently scheduled downlink control messages. The one or more first parameters, the one or more second parameters, or both may include one or more frequency resources, one or more time resources, a control region configuration or a control region index, a search space configuration or a search space index, one or more candidate locations, a control message format, or any combination thereof that are associated with the semi-persistently scheduled downlink control messages.

At 315, the UE 115 may monitor for a control message. For example, the UE 115 may monitor for a semi-persistently scheduled downlink control message based on the second control message activating the monitoring at 310. The UE 115 may monitor for the semi-persistently scheduled downlink control message of the semi-persistently scheduled downlink control messages in a CORESET, a search space, or both. That is, the semi-persistently scheduled downlink control message may be in a CORESET, a search space, or both. Additionally, or alternatively, the UE 115 may monitor for the semi-persistently scheduled downlink control message in a first control region that is different from a second control region in which the first control message is received. In other words, the semi-persistently scheduled downlink control message may be in a separate control region. In some examples, the UE 115 may monitor for the semi-persistently scheduled downlink control message in one or more time-frequency resources, where the one or more first parameters, the one or more second parameters, or both include the one or more time-frequency resources. That is, the semi-persistently scheduled downlink control message may be in indicated time-frequency resources.

At 320, the UE 115 may perform blind decoding. For example, the UE 115 may perform a blind decoding procedure in one or more candidate locations for the semi-persistently scheduled downlink control message, where the one or more candidate locations are in accordance with the one or more first parameters, the one or more second parameters, or both. That is, the UE 115 may perform the blind decoding procedure based on the first control message, the second control message, or both.

At 325, the network entity 105 may output, and the UE 115 may receive, a semi-persistent control message. For example, the UE 115 may receive a downlink control message of the semi-persistently scheduled downlink control messages based on the one or more first parameters, the one or more second parameters, or both, where the downlink control message includes one or more third parameters associated with reception of a downlink data message. The downlink control message may be an example of the semi-persistent control messages 215 as described with reference to FIG. 2. In some examples, the downlink control message may be a DCI message.

The one or more third parameters of the downlink control message may include a slot offset, a frequency domain allocation, a time domain allocation, an MCS, or any combination thereof associated with the downlink data message. In some examples, the one or more third parameters may include one or more fields that indicate one or more reception occasions to be skipped. In such examples, the UE 115 may refrain from monitoring for data messages during the indicated reception occasions. In some examples, a first CRC of the downlink control message may be the same as or smaller than a second CRC of the second control message.

The network entity 105 may output the semi-persistent control message in the CORESET, the search space, or both. Alternatively, the network entity 105 may output the semi-persistent control message in the first control region that is different from the second control region in which the first control message is received. In some other examples, the network entity 105 may output the semi-persistent control message in the one or more time-frequency resources indicated by the first parameters, the second parameters, or both.

At 330, the UE 115 may monitor for the data message. For example, the UE 115 may monitor for a downlink data message based on the one or more first parameters, the one or more second parameters, the one or more third parameters from the downlink control message of the semi-persistently scheduled downlink control messages, or any combination thereof. In some examples, the UE 115 may refrain from monitoring for the data message.

For example, the UE 115 may fail to receive the semi-persistent control message. In such examples, the UE 115 may refrain from monitoring for the downlink data message based on failing to receive the semi-persistent control message. Alternatively, the UE 115 may monitor for the downlink data message based on the one or more first parameters, the one or more second parameters, or both based on failing to receive the downlink control message. That is, the UE 115 may monitor for the downlink data message absent parameters included in a semi-persistent control message and instead use previously indicated or default parameters received in prior control messages.

The one or more downlink data messages may satisfy a threshold level of variation in packet size, have jitter, or both. For example, the downlink data messages may be examples of video packets in an XR application, where there is variability in the data packets. In such examples, the first control message may be received in accordance with the threshold level of variation in packet size, the jitter, or both. That is, the network entity 105 may configure the UE 115 with the semi-persistent control messages (e.g., rather than semi-persistent data messages) due to the variability in data packets.

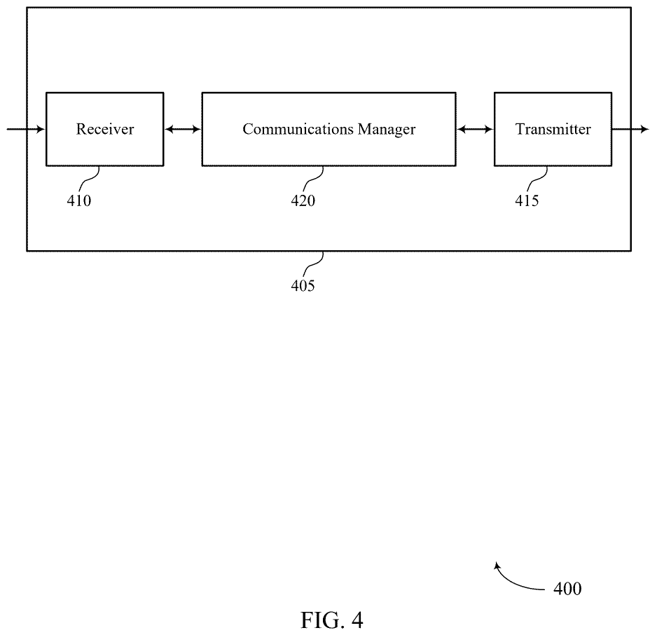

FIG. 4 shows a block diagram 400 of a device 405 that supports semi-persistently scheduled downlink control messages in accordance with one or more aspects of the present disclosure. The device 405 may be an example of aspects of a UE 115 as described herein. The device 405 may include a receiver 410, a transmitter 415, and a communications manager 420. The device 405, or one or more components of the device 405 (e.g., the receiver 410, the transmitter 415, the communications manager 420), may include at least one processor, which may be coupled with at least one memory, to, individually or collectively, support or enable the described techniques. Each of these components may be in communication with one another (e.g., via one or more buses).

The receiver 410 may provide a means for receiving information such as packets, user data, control information, or any combination thereof associated with various information channels (e.g., control channels, data channels, information channels related to semi-persistently scheduled downlink control messages). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to semi-persistently scheduled downlink control messages). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations or components thereof may be examples of means for performing various aspects of semi-persistently scheduled downlink control messages as described herein. For example, the communications manager 420, the receiver 410, the transmitter 415, or various combinations or components thereof may be capable of performing one or more of the functions described herein.

In some examples, the communications manager 420, the receiver 410, the transmitter 415, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 420, the receiver 410, the transmitter 415, or various combinations or components thereof may be implemented in code (e.g., as communications management software or firmware) executed by at least one processor (e.g., referred to as a processor-executable code). If implemented in code executed by at least one processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communications in accordance with examples as disclosed herein. For example, the communications manager 420 is capable of, configured to, or operable to support a means for receiving a first control message indicating a configuration including one or more first parameters associated with semi-persistently scheduled downlink control messages, where the semi-persistently scheduled downlink control messages includes scheduling information for one or more downlink data messages. The communications manager 420 is capable of, configured to, or operable to support a means for receiving a second control message activating monitoring for the semi-persistently scheduled downlink control messages, the second control message including one or more second parameters associated with the semi-persistently scheduled downlink control messages. The communications manager 420 is capable of, configured to, or operable to support a means for monitoring for a downlink data message based on the one or more first parameters, the one or more second parameters, one or more third parameters from a downlink control message of the semi-persistently scheduled downlink control messages, or any combination thereof.

By including or configuring the communications manager 420 in accordance with examples as described herein, the device 405 (e.g., at least one processor controlling or otherwise coupled with the receiver 410, the transmitter 415, the communications manager 420, or a combination thereof) may support techniques for more efficient utilization of communication resources.

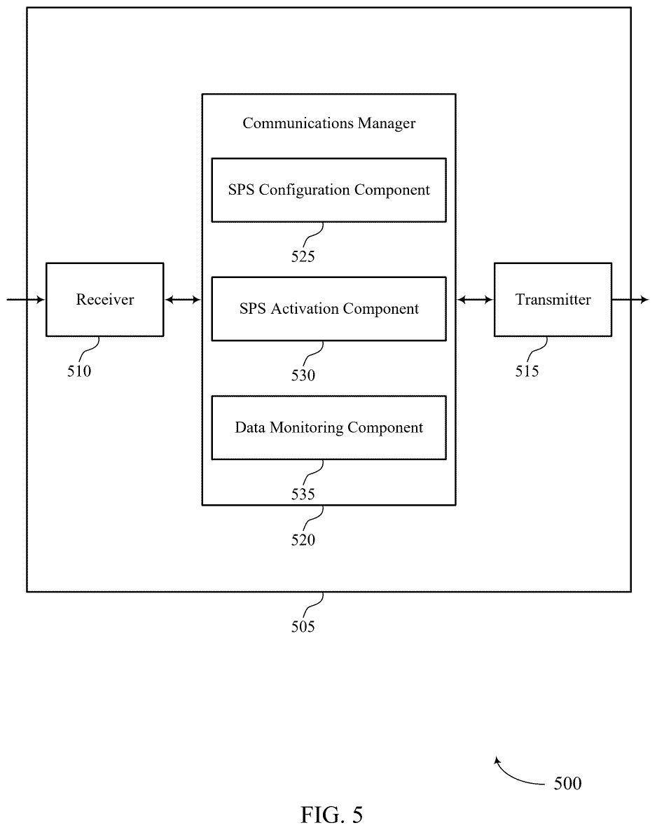

FIG. 5 shows a block diagram 500 of a device 505 that supports semi-persistently scheduled downlink control messages in accordance with one or more aspects of the present disclosure. The device 505 may be an example of aspects of a device 405 or a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to support the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to semi-persistently scheduled downlink control messages). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to semi-persistently scheduled downlink control messages). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of semi-persistently scheduled downlink control messages as described herein. For example, the communications manager 520 may include an SPS configuration component 525, an SPS activation component 530, a data monitoring component 535, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. The SPS configuration component 525 is capable of, configured to, or operable to support a means for receiving a first control message indicating a configuration including one or more first parameters associated with semi-persistently scheduled downlink control messages, where the semi-persistently scheduled downlink control messages includes scheduling information for one or more downlink data messages. The SPS activation component 530 is capable of, configured to, or operable to support a means for receiving a second control message activating monitoring for the semi-persistently scheduled downlink control messages, the second control message including one or more second parameters associated with the semi-persistently scheduled downlink control messages. The data monitoring component 535 is capable of, configured to, or operable to support a means for monitoring for a downlink data message based on the one or more first parameters, the one or more second parameters, one or more third parameters from a downlink control message of the semi-persistently scheduled downlink control messages, or any combination thereof.

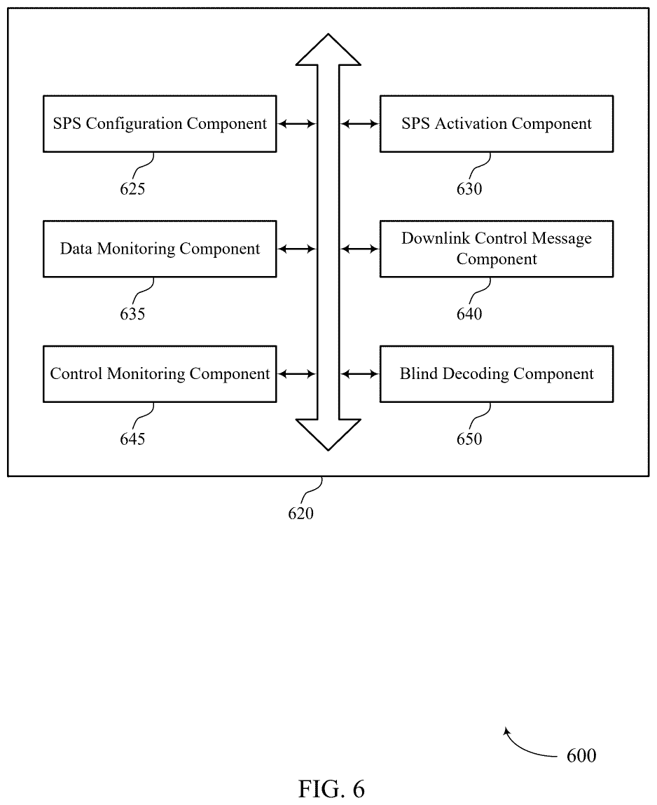

FIG. 6 shows a block diagram 600 of a communications manager 620 that supports semi-persistently scheduled downlink control messages in accordance with one or more aspects of the present disclosure. The communications manager 620 may be an example of aspects of a communications manager 420, a communications manager 520, or both, as described herein. The communications manager 620, or various components thereof, may be an example of means for performing various aspects of semi-persistently scheduled downlink control messages as described herein. For example, the communications manager 620 may include an SPS configuration component 625, an SPS activation component 630, a data monitoring component 635, a downlink control message component 640, a control monitoring component 645, a blind decoding component 650, or any combination thereof. Each of these components, or components or subcomponents thereof (e.g., one or more processors, one or more memories), may communicate, directly or indirectly, with one another (e.g., via one or more buses).

The communications manager 620 may support wireless communications in accordance with examples as disclosed herein. The SPS configuration component 625 is capable of, configured to, or operable to support a means for receiving a first control message indicating a configuration including one or more first parameters associated with semi-persistently scheduled downlink control messages, where the semi-persistently scheduled downlink control messages includes scheduling information for one or more downlink data messages. The SPS activation component 630 is capable of, configured to, or operable to support a means for receiving a second control message activating monitoring for the semi-persistently scheduled downlink control messages, the second control message including one or more second parameters associated with the semi-persistently scheduled downlink control messages. The data monitoring component 635 is capable of, configured to, or operable to support a means for monitoring for a downlink data message based on the one or more first parameters, the one or more second parameters, one or more third parameters from a downlink control message of the semi-persistently scheduled downlink control messages, or any combination thereof.

In some examples, the downlink control message component 640 is capable of, configured to, or operable to support a means for receiving the downlink control message of the semi-persistently scheduled downlink control messages based on the one or more first parameters, the one or more second parameters, or both, where the downlink control message includes the one or more third parameters associated with reception of the downlink data message.

In some examples, the one or more third parameters include one or more fields that indicate one or more reception occasions to be skipped.

In some examples, the control monitoring component 645 is capable of, configured to, or operable to support a means for monitoring for the downlink control message of the semi-persistently scheduled downlink control messages. In some examples, the data monitoring component 635 is capable of, configured to, or operable to support a means for refraining from monitoring for the downlink data message based on failing to receive the downlink control message.

In some examples, the control monitoring component 645 is capable of, configured to, or operable to support a means for monitoring for the downlink control message of the semi-persistently scheduled downlink control messages in a CORESET, a search space, or both.

In some examples, the control monitoring component 645 is capable of, configured to, or operable to support a means for monitoring for the downlink control message of the semi-persistently scheduled downlink control messages in a first control region that is different from a second control region in which the first control message is received.

In some examples, the control monitoring component 645 is capable of, configured to, or operable to support a means for monitoring for the downlink control message of the semi-persistently scheduled downlink control messages in one or more time-frequency resources, where the one or more first parameters, the one or more second parameters, or both include the one or more time-frequency resources.

In some examples, the blind decoding component 650 is capable of, configured to, or operable to support a means for performing a blind decoding procedure in one or more candidate locations for the downlink control message of the semi-persistently scheduled downlink control messages, where the one or more candidate locations are in accordance with the one or more first parameters, the one or more second parameters, or both.

In some examples, the one or more first parameters, the one or more second parameters, or both include one or more frequency resources, one or more time resources, a control region configuration or a control region index, a search space configuration or a search space index, one or more candidate locations, a control message format, or any combination thereof that are associated with the semi-persistently scheduled downlink control messages.

In some examples, the one or more third parameters of the downlink control message include a slot offset, a frequency domain allocation, a time domain allocation, a MCS, or any combination thereof associated with the downlink data message.

In some examples, a first CRC of the downlink control message is the same as or smaller than a second CRC of the second control message.

In some examples, the control monitoring component 645 is capable of, configured to, or operable to support a means for monitoring for the downlink control message of the semi-persistently scheduled downlink control messages. In some examples, the data monitoring component 635 is capable of, configured to, or operable to support a means for monitoring for the downlink data message based on the one or more first parameters, the one or more second parameters, or both based on failing to receive the downlink control message.

In some examples, the first control message includes an RRC message, the second control message includes a DCI message, a MAC-CE message, or an RRC message, and the downlink control message includes a DCI message.

In some examples, the one or more downlink data messages satisfy a threshold level of variation in packet size, have jitter, or both. In some examples, the first control message is received in accordance with the threshold level of variation in packet size, the jitter, or both.

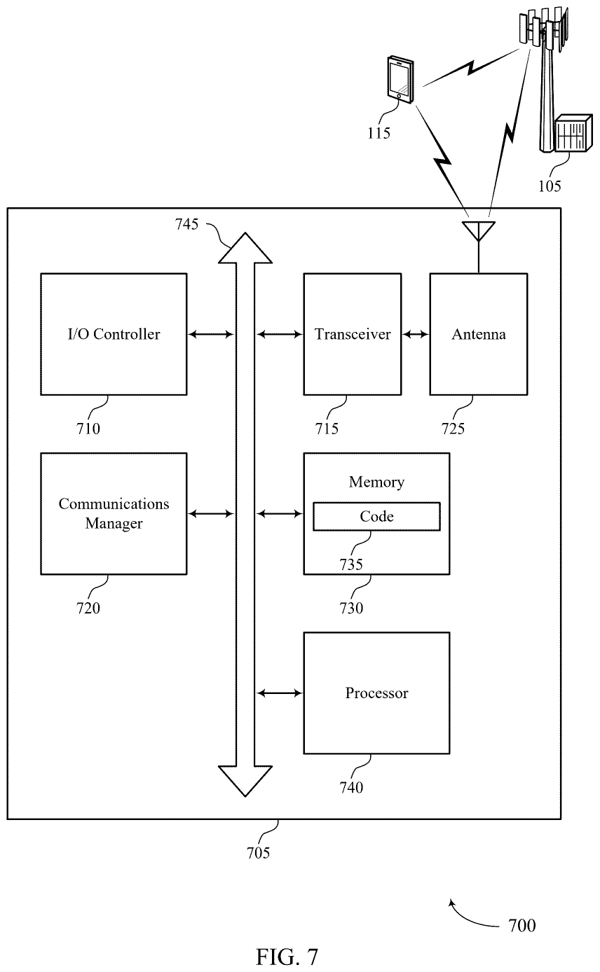

FIG. 7 shows a diagram of a system 700 including a device 705 that supports semi-persistently scheduled downlink control messages in accordance with one or more aspects of the present disclosure. The device 705 may be an example of or include components of a device 405, a device 505, or a UE 115 as described herein. The device 705 may communicate (e.g., wirelessly) with one or more other devices (e.g., network entities 105, UEs 115, or a combination thereof). The device 705 may include components for bi-directional voice and data communications including components for transmitting and receiving communications, such as a communications manager 720, an input/output (I/O) controller, such as an I/O controller 710, a transceiver 715, one or more antennas 725, at least one memory 730, code 735, and at least one processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of one or more processors, such as the at least one processor 740. In some cases, a user may interact with the device 705 via the I/O controller 710 or via hardware components controlled by the I/O controller 710.

In some cases, the device 705 may include a single antenna. However, in some other cases, the device 705 may have more than one antenna, which may be capable of concurrently transmitting or receiving multiple wireless transmissions. The transceiver 715 may communicate bi-directionally via the one or more antennas 725 using wired or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The at least one memory 730 may include random access memory (RAM) and read-only memory (ROM). The at least one memory 730 may store computer-readable, computer-executable, or processor-executable code, such as the code 735. The code 735 may include instructions that, when executed by the at least one processor 740, cause the device 705 to perform various functions described herein. The code 735 may be stored in a non-transitory computer-readable medium such as system memory or another type of memory. In some cases, the code 735 may not be directly executable by the at least one processor 740 but may cause a computer (e.g., when compiled and executed) to perform functions described herein. In some cases, the at least one memory 730 may include, among other things, a basic I/O system (BIOS) which may control basic hardware or software operation such as the interaction with peripheral components or devices.

The at least one processor 740 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 740 may be configured to operate a memory array using a memory controller. In some other cases, a memory controller may be integrated into the at least one processor 740. The at least one processor 740 may be configured to execute computer-readable instructions stored in a memory (e.g., the at least one memory 730) to cause the device 705 to perform various functions (e.g., functions or tasks supporting semi-persistently scheduled downlink control messages). For example, the device 705 or a component of the device 705 may include at least one processor 740 and at least one memory 730 coupled with or to the at least one processor 740, the at least one processor 740 and the at least one memory 730 configured to perform various functions described herein.

In some examples, the at least one processor 740 may include multiple processors and the at least one memory 730 may include multiple memories. One or more of the multiple processors may be coupled with one or more of the multiple memories, which may, individually or collectively, be configured to perform various functions described herein. In some examples, the at least one processor 740 may be a component of a processing system, which may refer to a system (such as a series) of machines, circuitry (including, for example, one or both of processor circuitry (which may include the at least one processor 740) and memory circuitry (which may include the at least one memory 730)), or components, that receives or obtains inputs and processes the inputs to produce, generate, or obtain a set of outputs. The processing system may be configured to perform one or more of the functions described herein. For example, the at least one processor 740 or a processing system including the at least one processor 740 may be configured to, configurable to, or operable to cause the device 705 to perform one or more of the functions described herein. Further, as described herein, being “configured to,” being “configurable to,” and being “operable to” may be used interchangeably and may be associated with a capability, when executing code 735 (e.g., processor-executable code) stored in the at least one memory 730 or otherwise, to perform one or more of the functions described herein.

The communications manager 720 may support wireless communications in accordance with examples as disclosed herein. For example, the communications manager 720 is capable of, configured to, or operable to support a means for receiving a first control message indicating a configuration including one or more first parameters associated with semi-persistently scheduled downlink control messages, where the semi-persistently scheduled downlink control messages includes scheduling information for one or more downlink data messages. The communications manager 720 is capable of, configured to, or operable to support a means for receiving a second control message activating monitoring for the semi-persistently scheduled downlink control messages, the second control message including one or more second parameters associated with the semi-persistently scheduled downlink control messages. The communications manager 720 is capable of, configured to, or operable to support a means for monitoring for a downlink data message based on the one or more first parameters, the one or more second parameters, one or more third parameters from a downlink control message of the semi-persistently scheduled downlink control messages, or any combination thereof.

By including or configuring the communications manager 720 in accordance with examples as described herein, the device 705 may support techniques for improved communication reliability, reduced latency, improved user experience related to reduced processing, more efficient utilization of communication resources, and improved coordination between devices.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the at least one processor 740, the at least one memory 730, the code 735, or any combination thereof. For example, the code 735 may include instructions executable by the at least one processor 740 to cause the device 705 to perform various aspects of semi-persistently scheduled downlink control messages as described herein, or the at least one processor 740 and the at least one memory 730 may be otherwise configured to, individually or collectively, perform or support such operations.

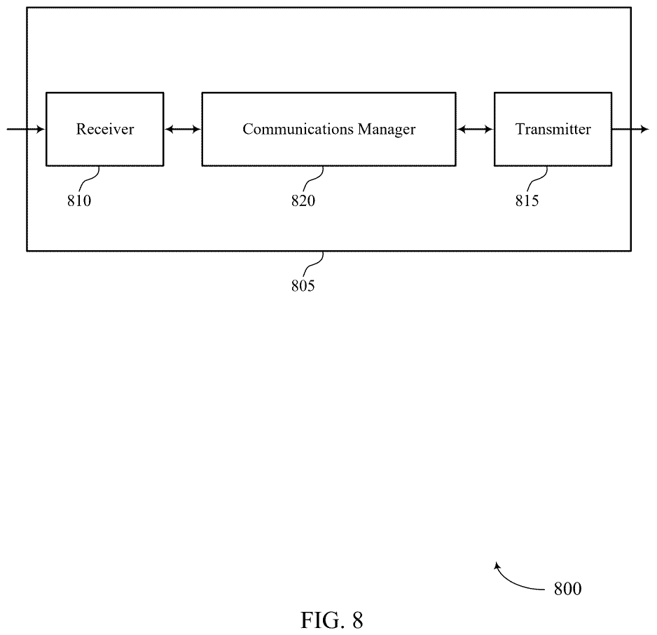

FIG. 8 shows a block diagram 800 of a device 805 that supports semi-persistently scheduled downlink control messages in accordance with one or more aspects of the present disclosure. The device 805 may be an example of aspects of a network entity 105 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to, individually or collectively, support or enable the described techniques. Each of these components may be in communication with one another (e.g., via one or more buses).

The receiver 810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 805. In some examples, the receiver 810 may support obtaining information by receiving signals via one or more antennas. Additionally, or alternatively, the receiver 810 may support obtaining information by receiving signals via one or more wired (e.g., electrical, fiber optic) interfaces, wireless interfaces, or any combination thereof.

The transmitter 815 may provide a means for outputting (e.g., transmitting, providing, conveying, sending) information generated by other components of the device 805. For example, the transmitter 815 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 815 may support outputting information by transmitting signals via one or more antennas. Additionally, or alternatively, the transmitter 815 may support outputting information by transmitting signals via one or more wired (e.g., electrical, fiber optic) interfaces, wireless interfaces, or any combination thereof. In some examples, the transmitter 815 and the receiver 810 may be co-located in a transceiver, which may include or be coupled with a modem.

The communications manager 820, the receiver 810, the transmitter 815, or various combinations or components thereof may be examples of means for performing various aspects of semi-persistently scheduled downlink control messages as described herein. For example, the communications manager 820, the receiver 810, the transmitter 815, or various combinations or components thereof may be capable of performing one or more of the functions described herein.

In some examples, the communications manager 820, the receiver 810, the transmitter 815, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the transmitter 815, or various combinations or components thereof may be implemented in code (e.g., as communications management software or firmware) executed by at least one processor (e.g., referred to as a processor-executable code). If implemented in code executed by at least one processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. For example, the communications manager 820 is capable of, configured to, or operable to support a means for outputting a first control message indicating a configuration including one or more first parameters associated with semi-persistently scheduled downlink control messages, where the semi-persistently scheduled downlink control messages includes scheduling information for one or more downlink data messages. The communications manager 820 is capable of, configured to, or operable to support a means for outputting a second control message activating monitoring for the semi-persistently scheduled downlink control messages, the second control message including one or more second parameters associated with the semi-persistently scheduled downlink control messages. The communications manager 820 is capable of, configured to, or operable to support a means for outputting for a downlink data message based on the one or more first parameters, the one or more second parameters, one or more third parameters from a downlink control message of the semi-persistently scheduled downlink control messages, or any combination thereof.

By including or configuring the communications manager 820 in accordance with examples as described herein, the device 805 (e.g., at least one processor controlling or otherwise coupled with the receiver 810, the transmitter 815, the communications manager 820, or a combination thereof) may support techniques for more efficient utilization of communication resources.

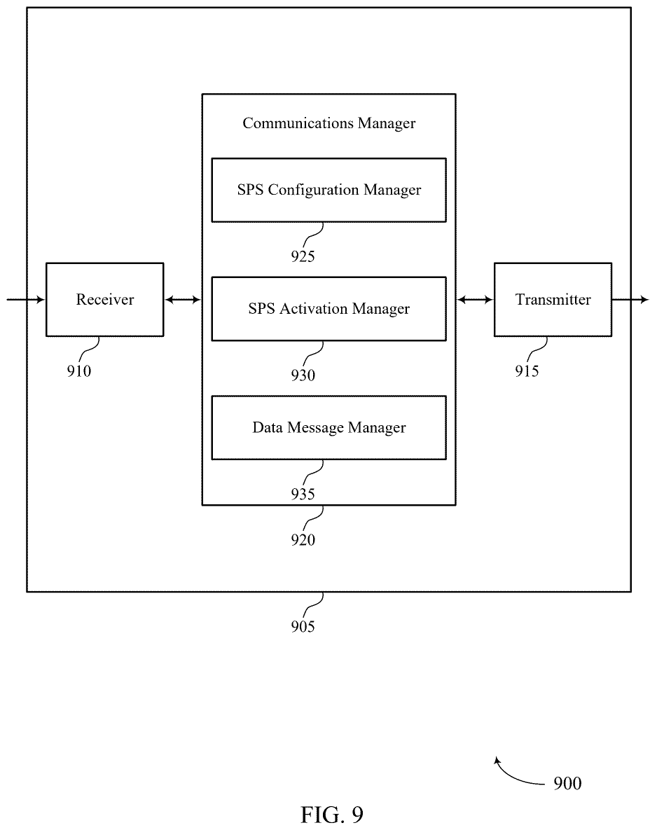

FIG. 9 shows a block diagram 900 of a device 905 that supports semi-persistently scheduled downlink control messages in accordance with one or more aspects of the present disclosure. The device 905 may be an example of aspects of a device 805 or a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to support the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The device 905, or various components thereof, may be an example of means for performing various aspects of semi-persistently scheduled downlink control messages as described herein. For example, the communications manager 920 may include an SPS configuration manager 925, an SPS activation manager 930, a data message manager 935, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. The SPS configuration manager 925 is capable of, configured to, or operable to support a means for outputting a first control message indicating a configuration including one or more first parameters associated with semi-persistently scheduled downlink control messages, where the semi-persistently scheduled downlink control messages includes scheduling information for one or more downlink data messages. The SPS activation manager 930 is capable of, configured to, or operable to support a means for outputting a second control message activating monitoring for the semi-persistently scheduled downlink control messages, the second control message including one or more second parameters associated with the semi-persistently scheduled downlink control messages. The data message manager 935 is capable of, configured to, or operable to support a means for outputting for a downlink data message based on the one or more first parameters, the one or more second parameters, one or more third parameters from a downlink control message of the semi-persistently scheduled downlink control messages, or any combination thereof.

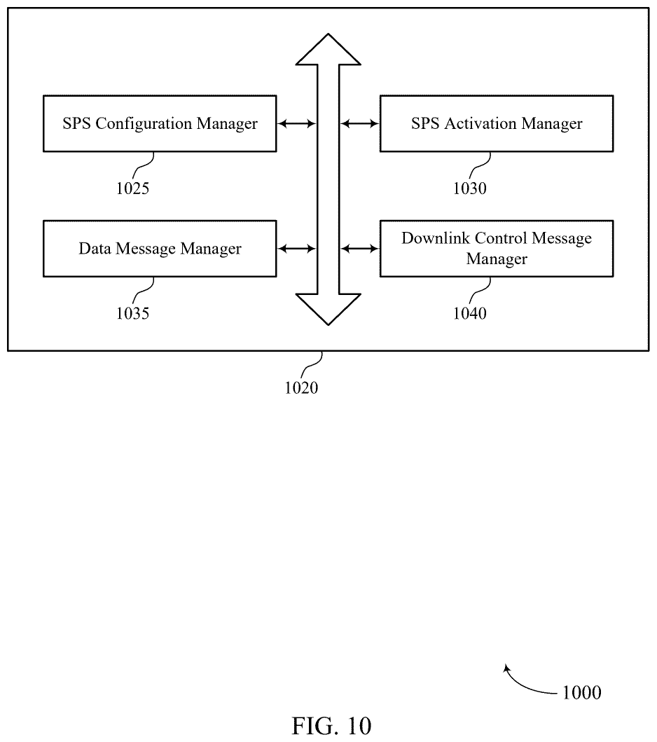

FIG. 10 shows a block diagram 1000 of a communications manager 1020 that supports semi-persistently scheduled downlink control messages in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of semi-persistently scheduled downlink control messages as described herein. For example, the communications manager 1020 may include an SPS configuration manager 1025, an SPS activation manager 1030, a data message manager 1035, a downlink control message manager 1040, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1020 may support wireless communications in accordance with examples as disclosed herein. The SPS configuration manager 1025 is capable of, configured to, or operable to support a means for outputting a first control message indicating a configuration including one or more first parameters associated with semi-persistently scheduled downlink control messages, where the semi-persistently scheduled downlink control messages includes scheduling information for one or more downlink data messages. The SPS activation manager 1030 is capable of, configured to, or operable to support a means for outputting a second control message activating monitoring for the semi-persistently scheduled downlink control messages, the second control message including one or more second parameters associated with the semi-persistently scheduled downlink control messages. The data message manager 1035 is capable of, configured to, or operable to support a means for outputting for a downlink data message based on the one or more first parameters, the one or more second parameters, one or more third parameters from a downlink control message of the semi-persistently scheduled downlink control messages, or any combination thereof.

In some examples, the downlink control message manager 1040 is capable of, configured to, or operable to support a means for outputting the downlink control message of the semi-persistently scheduled downlink control messages based on the one or more first parameters, the one or more second parameters, or both, where the downlink control message includes the one or more third parameters associated with reception of the downlink data message.

In some examples, the downlink control message is output in a CORESET, a search space, or both.

In some examples, the downlink control message is output in a first control region that is different from a second control region in which the first control message is received.

In some examples, the downlink control message is output via one or more time-frequency resources. In some examples, the one or more first parameters, the one or more second parameters, or both include the one or more time-frequency resources.

In some examples, the one or more first parameters, the one or more second parameters, or both include one or more frequency resources, one or more time resources, a control region configuration or a control region index, a search space configuration or a search space index, one or more candidate locations, a control message format, or any combination thereof that are associated with the semi-persistently scheduled downlink control messages.

In some examples, the one or more third parameters of the downlink control message include a slot offset, a frequency domain allocation, a time domain allocation, a MCS, or any combination thereof associated with the downlink data message.

In some examples, a first CRC of the downlink control message is the same as or smaller than a second CRC of the second control message.

In some examples, the first control message includes an RRC message, the second control message includes a DCI message, a MAC-CE message, or an RRC message, and the downlink control message includes a DCI message.

In some examples, the one or more downlink data messages satisfy a threshold level of variation in packet size, have jitter, or both. In some examples, the first control message is received in accordance with the threshold level of variation in packet size, the jitter, or both.

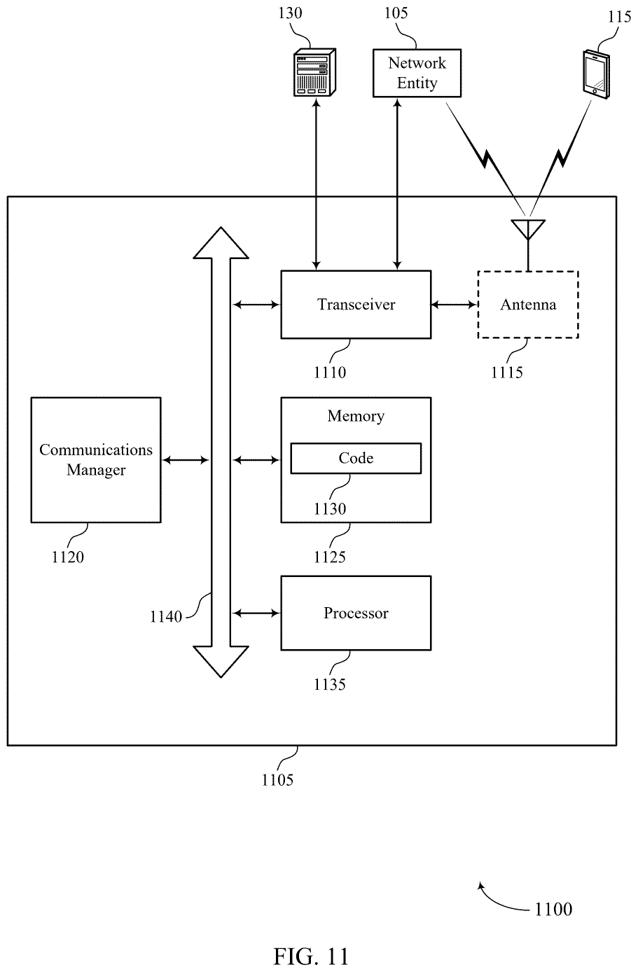

FIG. 11 shows a diagram of a system 1100 including a device 1105 that supports semi-persistently scheduled downlink control messages in accordance with one or more aspects of the present disclosure. The device 1105 may be an example of or include components of a device 805, a device 905, or a network entity 105 as described herein. The device 1105 may communicate with other network devices or network equipment such as one or more of the network entities 105, UEs 115, or any combination thereof. The communications may include communications over one or more wired interfaces, over one or more wireless interfaces, or any combination thereof. The device 1105 may include components that support outputting and obtaining communications, such as a communications manager 1120, a transceiver 1110, one or more antennas 1115, at least one memory 1125, code 1130, and at least one processor 1135. These components may be in electronic communication or otherwise coupled (e.g., operatively, communicatively, functionally, electronically, electrically) via one or more buses (e.g., a bus 1140).

The transceiver 1110 may support bi-directional communications via wired links, wireless links, or both as described herein. In some examples, the transceiver 1110 may include a wired transceiver and may communicate bi-directionally with another wired transceiver. Additionally, or alternatively, in some examples, the transceiver 1110 may include a wireless transceiver and may communicate bi-directionally with another wireless transceiver. In some examples, the device 1105 may include one or more antennas 1115, which may be capable of transmitting or receiving wireless transmissions (e.g., concurrently). The transceiver 1110 may also include a modem to modulate signals, to provide the modulated signals for transmission (e.g., by one or more antennas 1115, by a wired transmitter), to receive modulated signals (e.g., from one or more antennas 1115, from a wired receiver), and to demodulate signals. In some implementations, the transceiver 1110 may include one or more interfaces, such as one or more interfaces coupled with the one or more antennas 1115 that are configured to support various receiving or obtaining operations, or one or more interfaces coupled with the one or more antennas 1115 that are configured to support various transmitting or outputting operations, or a combination thereof. In some implementations, the transceiver 1110 may include or be configured for coupling with one or more processors or one or more memory components that are operable to perform or support operations based on received or obtained information or signals, or to generate information or other signals for transmission or other outputting, or any combination thereof. In some implementations, the transceiver 1110, or the transceiver 1110 and the one or more antennas 1115, or the transceiver 1110 and the one or more antennas 1115 and one or more processors or one or more memory components (e.g., the at least one processor 1135, the at least one memory 1125, or both), may be included in a chip or chip assembly that is installed in the device 1105. In some examples, the transceiver 1110 may be operable to support communications via one or more communications links (e.g., communication link(s) 125, backhaul communication link(s) 120, a midhaul communication link 162, a fronthaul communication link 168).

The at least one memory 1125 may include RAM, ROM, or any combination thereof. The at least one memory 1125 may store computer-readable, computer-executable, or processor-executable code, such as the code 1130. The code 1130 may include instructions that, when executed by one or more of the at least one processor 1135, cause the device 1105 to perform various functions described herein. The code 1130 may be stored in a non-transitory computer-readable medium such as system memory or another type of memory. In some cases, the code 1130 may not be directly executable by a processor of the at least one processor 1135 but may cause a computer (e.g., when compiled and executed) to perform functions described herein. In some cases, the at least one memory 1125 may include, among other things, a BIOS which may control basic hardware or software operation such as the interaction with peripheral components or devices. In some examples, the at least one processor 1135 may include multiple processors and the at least one memory 1125 may include multiple memories. One or more of the multiple processors may be coupled with one or more of the multiple memories which may, individually or collectively, be configured to perform various functions herein (for example, as part of a processing system).

The at least one processor 1135 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1135 may be configured to operate a memory array using a memory controller. In some other cases, a memory controller may be integrated into one or more of the at least one processor 1135. The at least one processor 1135 may be configured to execute computer-readable instructions stored in a memory (e.g., one or more of the at least one memory 1125) to cause the device 1105 to perform various functions (e.g., functions or tasks supporting semi-persistently scheduled downlink control messages). For example, the device 1105 or a component of the device 1105 may include at least one processor 1135 and at least one memory 1125 coupled with one or more of the at least one processor 1135, the at least one processor 1135 and the at least one memory 1125 configured to perform various functions described herein. The at least one processor 1135 may be an example of a cloud-computing platform (e.g., one or more physical nodes and supporting software such as operating systems, virtual machines, or container instances) that may host the functions (e.g., by executing code 1130) to perform the functions of the device 1105. The at least one processor 1135 may be any one or more suitable processors capable of executing scripts or instructions of one or more software programs stored in the device 1105 (such as within one or more of the at least one memory 1125).

In some examples, the at least one processor 1135 may include multiple processors and the at least one memory 1125 may include multiple memories. One or more of the multiple processors may be coupled with one or more of the multiple memories, which may, individually or collectively, be configured to perform various functions herein. In some examples, the at least one processor 1135 may be a component of a processing system, which may refer to a system (such as a series) of machines, circuitry (including, for example, one or both of processor circuitry (which may include the at least one processor 1135) and memory circuitry (which may include the at least one memory 1125)), or components, that receives or obtains inputs and processes the inputs to produce, generate, or obtain a set of outputs. The processing system may be configured to perform one or more of the functions described herein. For example, the at least one processor 1135 or a processing system including the at least one processor 1135 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code stored in the at least one memory 1125 or otherwise, to perform one or more of the functions described herein.

In some examples, a bus 1140 may support communications of (e.g., within) a protocol layer of a protocol stack. In some examples, a bus 1140 may support communications associated with a logical channel of a protocol stack (e.g., between protocol layers of a protocol stack), which may include communications performed within a component of the device 1105, or between different components of the device 1105 that may be co-located or located in different locations (e.g., where the device 1105 may refer to a system in which one or more of the communications manager 1120, the transceiver 1110, the at least one memory 1125, the code 1130, and the at least one processor 1135 may be located in one of the different components or divided between different components).

In some examples, the communications manager 1120 may manage aspects of communications with a core network 130 (e.g., via one or more wired or wireless backhaul links). For example, the communications manager 1120 may manage the transfer of data communications for client devices, such as one or more UEs 115. In some examples, the communications manager 1120 may manage communications with one or more other network entities 105, and may include a controller or scheduler for controlling communications with UEs 115 (e.g., in cooperation with the one or more other network devices). In some examples, the communications manager 1120 may support an X2 interface within an LTE/LTE-A wireless communications network technology to provide communication between network entities 105.

The communications manager 1120 may support wireless communications in accordance with examples as disclosed herein. For example, the communications manager 1120 is capable of, configured to, or operable to support a means for outputting a first control message indicating a configuration including one or more first parameters associated with semi-persistently scheduled downlink control messages, where the semi-persistently scheduled downlink control messages includes scheduling information for one or more downlink data messages. The communications manager 1120 is capable of, configured to, or operable to support a means for outputting a second control message activating monitoring for the semi-persistently scheduled downlink control messages, the second control message including one or more second parameters associated with the semi-persistently scheduled downlink control messages. The communications manager 1120 is capable of, configured to, or operable to support a means for outputting for a downlink data message based on the one or more first parameters, the one or more second parameters, one or more third parameters from a downlink control message of the semi-persistently scheduled downlink control messages, or any combination thereof.

By including or configuring the communications manager 1120 in accordance with examples as described herein, the device 1105 may support techniques for improved communication reliability, improved user experience related to reduced processing, more efficient utilization of communication resources, and improved coordination between devices.

In some examples, the communications manager 1120 may be configured to perform various operations (e.g., receiving, obtaining, monitoring, outputting, transmitting) using or otherwise in cooperation with the transceiver 1110, the one or more antennas 1115 (e.g., where applicable), or any combination thereof. Although the communications manager 1120 is illustrated as a separate component, in some examples, one or more functions described with reference to the communications manager 1120 may be supported by or performed by the transceiver 1110, one or more of the at least one processor 1135, one or more of the at least one memory 1125, the code 1130, or any combination thereof (for example, by a processing system including at least a portion of the at least one processor 1135, the at least one memory 1125, the code 1130, or any combination thereof). For example, the code 1130 may include instructions executable by one or more of the at least one processor 1135 to cause the device 1105 to perform various aspects of semi-persistently scheduled downlink control messages as described herein, or the at least one processor 1135 and the at least one memory 1125 may be otherwise configured to, individually or collectively, perform or support such operations.

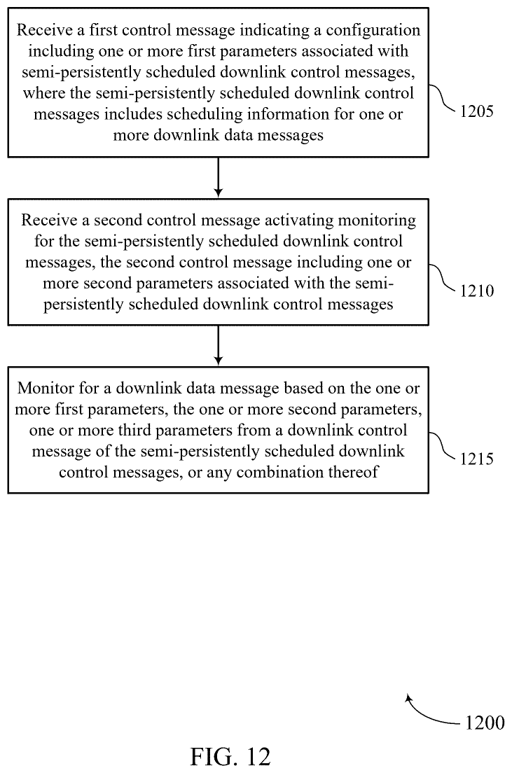

FIG. 12 shows a flowchart illustrating a method 1200 that supports semi-persistently scheduled downlink control messages in accordance with one or more aspects of the present disclosure. The operations of the method 1200 may be implemented by a UE or its components as described herein. For example, the operations of the method 1200 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1205, the method may include receiving a first control message indicating a configuration including one or more first parameters associated with semi-persistently scheduled downlink control messages, where the semi-persistently scheduled downlink control messages includes scheduling information for one or more downlink data messages. The operations of 1205 may be performed in accordance with examples as disclosed herein. In some examples, aspects of the operations of 1205 may be performed by an SPS configuration component 625 as described with reference to FIG. 6.

At 1210, the method may include receiving a second control message activating monitoring for the semi-persistently scheduled downlink control messages, the second control message including one or more second parameters associated with the semi-persistently scheduled downlink control messages. The operations of 1210 may be performed in accordance with examples as disclosed herein. In some examples, aspects of the operations of 1210 may be performed by an SPS activation component 630 as described with reference to FIG. 6.

At 1215, the method may include monitoring for a downlink data message based on the one or more first parameters, the one or more second parameters, one or more third parameters from a downlink control message of the semi-persistently scheduled downlink control messages, or any combination thereof. The operations of 1215 may be performed in accordance with examples as disclosed herein. In some examples, aspects of the operations of 1215 may be performed by a data monitoring component 635 as described with reference to FIG. 6.

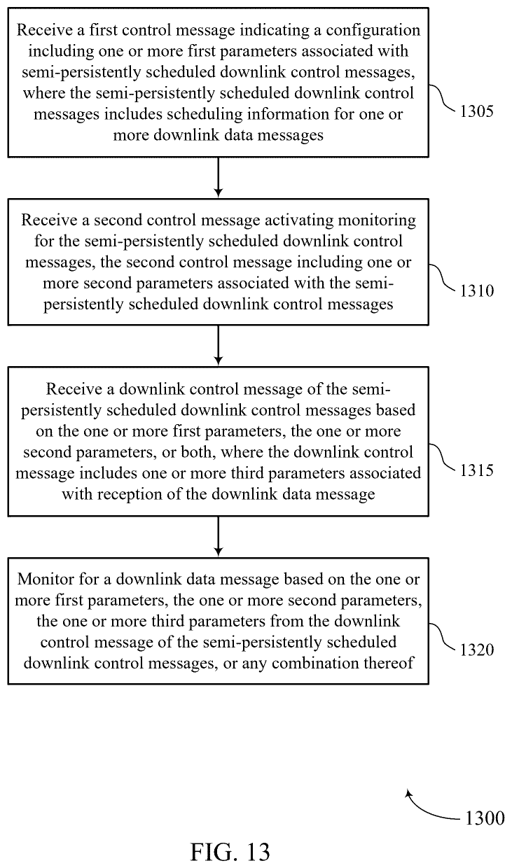

FIG. 13 shows a flowchart illustrating a method 1300 that supports semi-persistently scheduled downlink control messages in accordance with one or more aspects of the present disclosure. The operations of the method 1300 may be implemented by a UE or its components as described herein. For example, the operations of the method 1300 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1305, the method may include receiving a first control message indicating a configuration including one or more first parameters associated with semi-persistently scheduled downlink control messages, where the semi-persistently scheduled downlink control messages includes scheduling information for one or more downlink data messages. The operations of 1305 may be performed in accordance with examples as disclosed herein. In some examples, aspects of the operations of 1305 may be performed by an SPS configuration component 625 as described with reference to FIG. 6.

At 1310, the method may include receiving a second control message activating monitoring for the semi-persistently scheduled downlink control messages, the second control message including one or more second parameters associated with the semi-persistently scheduled downlink control messages. The operations of 1310 may be performed in accordance with examples as disclosed herein. In some examples, aspects of the operations of 1310 may be performed by an SPS activation component 630 as described with reference to FIG. 6.

At 1315, the method may include receiving a downlink control message of the semi-persistently scheduled downlink control messages based on the one or more first parameters, the one or more second parameters, or both, where the downlink control message includes one or more third parameters associated with reception of the downlink data message. The operations of 1315 may be performed in accordance with examples as disclosed herein. In some examples, aspects of the operations of 1315 may be performed by a downlink control message component 640 as described with reference to FIG. 6.

At 1320, the method may include monitoring for a downlink data message based on the one or more first parameters, the one or more second parameters, the one or more third parameters from the downlink control message of the semi-persistently scheduled downlink control messages, or any combination thereof. The operations of 1320 may be performed in accordance with examples as disclosed herein. In some examples, aspects of the operations of 1320 may be performed by a data monitoring component 635 as described with reference to FIG. 6.

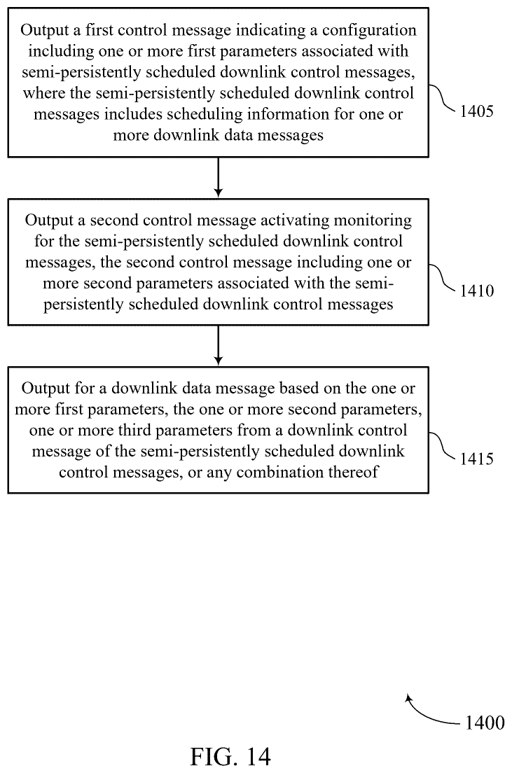

FIG. 14 shows a flowchart illustrating a method 1400 that supports semi-persistently scheduled downlink control messages in accordance with one or more aspects of the present disclosure. The operations of the method 1400 may be implemented by a network entity or its components as described herein. For example, the operations of the method 1400 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1405, the method may include outputting a first control message indicating a configuration including one or more first parameters associated with semi-persistently scheduled downlink control messages, where the semi-persistently scheduled downlink control messages includes scheduling information for one or more downlink data messages. The operations of 1405 may be performed in accordance with examples as disclosed herein. In some examples, aspects of the operations of 1405 may be performed by an SPS configuration manager 1025 as described with reference to FIG. 10.

At 1410, the method may include outputting a second control message activating monitoring for the semi-persistently scheduled downlink control messages, the second control message including one or more second parameters associated with the semi-persistently scheduled downlink control messages. The operations of 1410 may be performed in accordance with examples as disclosed herein. In some examples, aspects of the operations of 1410 may be performed by an SPS activation manager 1030 as described with reference to FIG. 10.

At 1415, the method may include outputting for a downlink data message based on the one or more first parameters, the one or more second parameters, one or more third parameters from a downlink control message of the semi-persistently scheduled downlink control messages, or any combination thereof. The operations of 1415 may be performed in accordance with examples as disclosed herein. In some examples, aspects of the operations of 1415 may be performed by a data message manager 1035 as described with reference to FIG. 10.

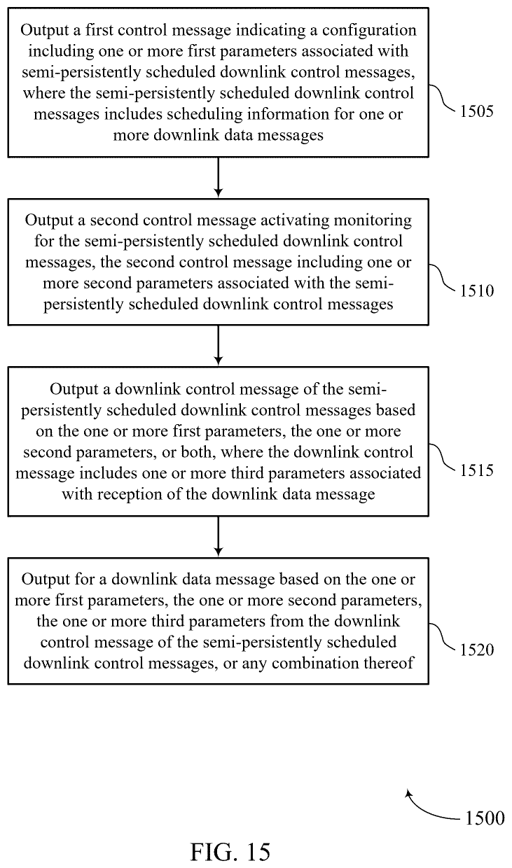

FIG. 15 shows a flowchart illustrating a method 1500 that supports semi-persistently scheduled downlink control messages in accordance with one or more aspects of the present disclosure. The operations of the method 1500 may be implemented by a network entity or its components as described herein. For example, the operations of the method 1500 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1505, the method may include outputting a first control message indicating a configuration including one or more first parameters associated with semi-persistently scheduled downlink control messages, where the semi-persistently scheduled downlink control messages includes scheduling information for one or more downlink data messages. The operations of 1505 may be performed in accordance with examples as disclosed herein. In some examples, aspects of the operations of 1505 may be performed by an SPS configuration manager 1025 as described with reference to FIG. 10.

At 1510, the method may include outputting a second control message activating monitoring for the semi-persistently scheduled downlink control messages, the second control message including one or more second parameters associated with the semi-persistently scheduled downlink control messages. The operations of 1510 may be performed in accordance with examples as disclosed herein. In some examples, aspects of the operations of 1510 may be performed by an SPS activation manager 1030 as described with reference to FIG. 10.

At 1515, the method may include outputting a downlink control message of the semi-persistently scheduled downlink control messages based on the one or more first parameters, the one or more second parameters, or both, where the downlink control message includes one or more third parameters associated with reception of the downlink data message. The operations of 1515 may be performed in accordance with examples as disclosed herein. In some examples, aspects of the operations of 1515 may be performed by a downlink control message manager 1040 as described with reference to FIG. 10.

At 1520, the method may include outputting for a downlink data message based on the one or more first parameters, the one or more second parameters, the one or more third parameters from the downlink control message of the semi-persistently scheduled downlink control messages, or any combination thereof. The operations of 1520 may be performed in accordance with examples as disclosed herein. In some examples, aspects of the operations of 1520 may be performed by a data message manager 1035 as described with reference to FIG. 10.

The following provides an overview of aspects of the present disclosure:

Aspect 1: A method for wireless communications by a UE, comprising: receiving a first control message indicating a configuration comprising one or more first parameters associated with semi-persistently scheduled downlink control messages, wherein the semi-persistently scheduled downlink control messages comprises scheduling information for one or more downlink data messages; receiving a second control message activating monitoring for the semi-persistently scheduled downlink control messages, the second control message comprising one or more second parameters associated with the semi-persistently scheduled downlink control messages; and monitoring for a downlink data message based at least in part on the one or more first parameters, the one or more second parameters, one or more third parameters from a downlink control message of the semi-persistently scheduled downlink control messages, or any combination thereof.

Aspect 2: The method of aspect 1, further comprising: receiving the downlink control message of the semi-persistently scheduled downlink control messages based at least in part on the one or more first parameters, the one or more second parameters, or both, wherein the downlink control message comprises the one or more third parameters associated with reception of the downlink data message.

Aspect 3: The method of aspect 2, wherein the one or more third parameters comprise one or more fields that indicate one or more reception occasions to be skipped.

Aspect 4: The method of any of aspects 1 through 3, further comprising: monitoring for the downlink control message of the semi-persistently scheduled downlink control messages; and refraining from monitoring for the downlink data message based at least in part on failing to receive the downlink control message.

Aspect 5: The method of any of aspects 1 through 4, further comprising: monitoring for the downlink control message of the semi-persistently scheduled downlink control messages in a CORESET, a search space, or both.

Aspect 6: The method of any of aspects 1 through 5, further comprising: monitoring for the downlink control message of the semi-persistently scheduled downlink control messages in a first control region that is different from a second control region in which the first control message is received.

Aspect 7: The method of any of aspects 1 through 6, further comprising: monitoring for the downlink control message of the semi-persistently scheduled downlink control messages in one or more time-frequency resources, wherein the one or more first parameters, the one or more second parameters, or both include the one or more time-frequency resources.

Aspect 8: The method of any of aspects 1 through 7, further comprising: performing a blind decoding procedure in one or more candidate locations for the downlink control message of the semi-persistently scheduled downlink control messages, wherein the one or more candidate locations are in accordance with the one or more first parameters, the one or more second parameters, or both.

Aspect 9: The method of any of aspects 1 through 8, wherein the one or more first parameters, the one or more second parameters, or both comprise one or more frequency resources, one or more time resources, a control region configuration or a control region index, a search space configuration or a search space index, one or more candidate locations, a control message format, or any combination thereof that are associated with the semi-persistently scheduled downlink control messages.

Aspect 10: The method of any of aspects 1 through 9, wherein the one or more third parameters of the downlink control message include a slot offset, a frequency domain allocation, a time domain allocation, an MCS, or any combination thereof associated with the downlink data message.

Aspect 11: The method of any of aspects 1 through 10, wherein a first CRC of the downlink control message is the same as or smaller than a second CRC of the second control message.

Aspect 12: The method of any of aspects 1 through 11, further comprising: monitoring for the downlink control message of the semi-persistently scheduled downlink control messages; and monitoring for the downlink data message based on the one or more first parameters, the one or more second parameters, or both based at least in part on failing to receive the downlink control message.

Aspect 13: The method of any of aspects 1 through 12, wherein the first control message comprises an RRC message, the second control message comprises a DCI message, a MAC-CE message, or an RRC message, and the downlink control message comprises a DCI message.

Aspect 14: The method of any of aspects 1 through 13, wherein the one or more downlink data messages satisfy a threshold level of variation in packet size, have jitter, or both, and the first control message is received in accordance with the threshold level of variation in packet size, the jitter, or both.

Aspect 15: A method for wireless communications by a network entity, comprising: outputting a first control message indicating a configuration comprising one or more first parameters associated with semi-persistently scheduled downlink control messages, wherein the semi-persistently scheduled downlink control messages comprises scheduling information for one or more downlink data messages; outputting a second control message activating monitoring for the semi-persistently scheduled downlink control messages, the second control message comprising one or more second parameters associated with the semi-persistently scheduled downlink control messages; and outputting for a downlink data message based at least in part on the one or more first parameters, the one or more second parameters, one or more third parameters from a downlink control message of the semi-persistently scheduled downlink control messages, or any combination thereof.

Aspect 16: The method of aspect 15, further comprising: outputting the downlink control message of the semi-persistently scheduled downlink control messages based at least in part on the one or more first parameters, the one or more second parameters, or both, wherein the downlink control message comprises the one or more third parameters associated with reception of the downlink data message.

Aspect 17: The method of aspect 16, wherein the downlink control message is output in a CORESET, a search space, or both.

Aspect 18: The method of any of aspects 16 through 17, wherein the downlink control message is output in a first control region that is different from a second control region in which the first control message is received.

Aspect 19: The method of any of aspects 16 through 18, further wherein the downlink control message is output via one or more time-frequency resources, the one or more first parameters, the one or more second parameters, or both include the one or more time-frequency resources.

Aspect 20: The method of any of aspects 15 through 19, wherein the one or more first parameters, the one or more second parameters, or both comprise one or more frequency resources, one or more time resources, a control region configuration or a control region index, a search space configuration or a search space index, one or more candidate locations, a control message format, or any combination thereof that are associated with the semi-persistently scheduled downlink control messages.

Aspect 21: The method of any of aspects 15 through 20, wherein the one or more third parameters of the downlink control message include a slot offset, a frequency domain allocation, a time domain allocation, an MCS, or any combination thereof associated with the downlink data message.

Aspect 22: The method of any of aspects 15 through 21, wherein a first CRC of the downlink control message is the same as or smaller than a second CRC of the second control message.

Aspect 23: The method of any of aspects 15 through 22, wherein the first control message comprises an RRC message, the second control message comprises a DCI message, a MAC-CE message, or an RRC message, and the downlink control message comprises a DCI message.

Aspect 24: The method of any of aspects 15 through 23, wherein the one or more downlink data messages satisfy a threshold level of variation in packet size, have jitter, or both, and the first control message is received in accordance with the threshold level of variation in packet size, the jitter, or both.

Aspect 25: A UE for wireless communications, comprising one or more memories storing processor-executable code, and one or more processors coupled with the one or more memories and individually or collectively operable to execute the code to cause the UE to perform a method of any of aspects 1 through 14.

Aspect 26: A UE for wireless communications, comprising at least one means for performing a method of any of aspects 1 through 14.

Aspect 27: A non-transitory computer-readable medium storing code for wireless communications, the code comprising instructions executable by one or more processors to perform a method of any of aspects 1 through 14.

Aspect 28: A network entity for wireless communications, comprising one or more memories storing processor-executable code, and one or more processors coupled with the one or more memories and individually or collectively operable to execute the code to cause the network entity to perform a method of any of aspects 15 through 24.

Aspect 29: A network entity for wireless communications, comprising at least one means for performing a method of any of aspects 15 through 24.

Aspect 30: A non-transitory computer-readable medium storing code for wireless communications, the code comprising instructions executable by one or more processors to perform a method of any of aspects 15 through 24.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive a first control message indicating a configuration comprising one or more first parameters associated with semi-persistently scheduled downlink control messages, wherein the semi-persistently scheduled downlink control messages comprises scheduling information for one or more downlink data messages;
receive a second control message activating monitoring for the semi-persistently scheduled downlink control messages, the second control message comprising one or more second parameters associated with the semi-persistently scheduled downlink control messages; and
monitor for a downlink data message based at least in part on the one or more first parameters, the one or more second parameters, one or more third parameters from a downlink control message of the semi-persistently scheduled downlink control messages, or any combination thereof.

2. The UE of claim 1, wherein the one or more processors are individually or collectively further operable to execute the code to cause the UE to:
receive the downlink control message of the semi-persistently scheduled downlink control messages based at least in part on the one or more first parameters, the one or more second parameters, or both, wherein the downlink control message comprises the one or more third parameters associated with reception of the downlink data message.

3. The UE of claim 2, wherein:
the one or more third parameters comprise one or more fields that indicate one or more reception occasions to be skipped.

4. The UE of claim 1, wherein the one or more processors are individually or collectively further operable to execute the code to cause the UE to:
monitor for the downlink control message of the semi-persistently scheduled downlink control messages; and
refrain from monitoring for the downlink data message based at least in part on failing to receive the downlink control message.

5. The UE of claim 1, wherein the one or more processors are individually or collectively further operable to execute the code to cause the UE to:
monitor for the downlink control message of the semi-persistently scheduled downlink control messages in a control resource set (CORESET), a search space, or both.

6. The UE of claim 1, wherein the one or more processors are individually or collectively further operable to execute the code to cause the UE to:
monitor for the downlink control message of the semi-persistently scheduled downlink control messages in a first control region that is different from a second control region in which the first control message is received.

7. The UE of claim 1, wherein the one or more processors are individually or collectively further operable to execute the code to cause the UE to:
monitor for the downlink control message of the semi-persistently scheduled downlink control messages in one or more time-frequency resources, wherein the one or more first parameters, the one or more second parameters, or both include the one or more time-frequency resources.

8. The UE of claim 1, wherein the one or more processors are individually or collectively further operable to execute the code to cause the UE to:
perform a blind decoding procedure in one or more candidate locations for the downlink control message of the semi-persistently scheduled downlink control messages, wherein the one or more candidate locations are in accordance with the one or more first parameters, the one or more second parameters, or both.

9. The UE of claim 1, wherein the one or more first parameters, the one or more second parameters, or both comprise one or more frequency resources, one or more time resources, a control region configuration or a control region index, a search space configuration or a search space index, one or more candidate locations, a control message format, or any combination thereof that are associated with the semi-persistently scheduled downlink control messages.

10. The UE of claim 1, wherein the one or more third parameters of the downlink control message include a slot offset, a frequency domain allocation, a time domain allocation, a modulation and coding scheme (MCS), or any combination thereof associated with the downlink data message.

11. The UE of claim 1, wherein a first cyclic redundancy check (CRC) of the downlink control message is the same as or smaller than a second CRC of the second control message.

12. The UE of claim 1, wherein the one or more processors are individually or collectively further operable to execute the code to cause the UE to:
monitor for the downlink control message of the semi-persistently scheduled downlink control messages; and
monitor for the downlink data message based on the one or more first parameters, the one or more second parameters, or both based at least in part on failing to receive the downlink control message.

13. The UE of claim 1, wherein:
the first control message comprises a radio resource control (RRC) message,
the second control message comprises a downlink control information (DCI) message, a medium access control (MAC)-control element (CE) message, or an RRC message, and
the downlink control message comprises a DCI message.

14. The UE of claim 1, wherein:
the one or more downlink data messages satisfy a threshold level of variation in packet size, have jitter, or both, and
the first control message is received in accordance with the threshold level of variation in packet size, the jitter, or both.

15. A network entity, comprising:
one or more memories storing processor-executable code; and
one or more processors coupled with the one or more memories and individually or collectively operable to execute the code to cause the network entity to:
output a first control message indicating a configuration comprising one or more first parameters associated with semi-persistently scheduled downlink control messages, wherein the semi-persistently scheduled downlink control messages comprises scheduling information for one or more downlink data messages;
output a second control message activating monitoring for the semi-persistently scheduled downlink control messages, the second control message comprising one or more second parameters associated with the semi-persistently scheduled downlink control messages; and
output for a downlink data message based at least in part on the one or more first parameters, the one or more second parameters, one or more third parameters from a downlink control message of the semi-persistently scheduled downlink control messages, or any combination thereof.

16. The network entity of claim 15, wherein the one or more processors are individually or collectively further operable to execute the code to cause the network entity to:
output the downlink control message of the semi-persistently scheduled downlink control messages based at least in part on the one or more first parameters, the one or more second parameters, or both, wherein the downlink control message comprises the one or more third parameters associated with reception of the downlink data message.

17. The network entity of claim 16, wherein the downlink control message is output in a control resource set (CORESET), a search space, or both.

18. The network entity of claim 16, wherein the downlink control message is output in a first control region that is different from a second control region in which the first control message is received.

19. The network entity of claim 16, wherein the downlink control message is output via one or more time-frequency resources, wherein the one or more first parameters, the one or more second parameters, or both include the one or more time-frequency resources.

20. The network entity of claim 15, wherein the one or more first parameters, the one or more second parameters, or both comprise one or more frequency resources, one or more time resources, a control region configuration or a control region index, a search space configuration or a search space index, one or more candidate locations, a control message format, or any combination thereof that are associated with the semi-persistently scheduled downlink control messages.

21. The network entity of claim 15, wherein the one or more third parameters of the downlink control message include a slot offset, a frequency domain allocation, a time domain allocation, a modulation and coding scheme (MCS), or any combination thereof associated with the downlink data message.

22. The network entity of claim 15, wherein a first cyclic redundancy check (CRC) of the downlink control message is the same as or smaller than a second CRC of the second control message.

23. The network entity of claim 15, wherein:
the first control message comprises a radio resource control (RRC) message,
the second control message comprises a downlink control information (DCI) message, a medium access control (MAC)-control element (CE) message, or an RRC message, and
the downlink control message comprises a DCI message.

24. The network entity of claim 15, wherein:
the one or more downlink data messages satisfy a threshold level of variation in packet size, have jitter, or both, and
the first control message is received in accordance with the threshold level of variation in packet size, the jitter, or both.

25. A method for wireless communications by a user equipment (UE), comprising:
receiving a first control message indicating a configuration comprising one or more first parameters associated with semi-persistently scheduled downlink control messages, wherein the semi-persistently scheduled downlink control messages comprises scheduling information for one or more downlink data messages;
receiving a second control message activating monitoring for the semi-persistently scheduled downlink control messages, the second control message comprising one or more second parameters associated with the semi-persistently scheduled downlink control messages; and
monitoring for a downlink data message based at least in part on the one or more first parameters, the one or more second parameters, one or more third parameters from a downlink control message of the semi-persistently scheduled downlink control messages, or any combination thereof.

26. The method of claim 25, further comprising:
receiving the downlink control message of the semi-persistently scheduled downlink control messages based at least in part on the one or more first parameters, the one or more second parameters, or both, wherein the downlink control message comprises the one or more third parameters associated with reception of the downlink data message.

27. The method of claim 26, wherein the one or more third parameters comprise one or more fields that indicate one or more reception occasions to be skipped.

28. A method for wireless communications by a network entity, comprising:
outputting a first control message indicating a configuration comprising one or more first parameters associated with semi-persistently scheduled downlink control messages, wherein the semi-persistently scheduled downlink control messages comprises scheduling information for one or more downlink data messages;
outputting a second control message activating monitoring for the semi-persistently scheduled downlink control messages, the second control message comprising one or more second parameters associated with the semi-persistently scheduled downlink control messages; and
outputting for a downlink data message based at least in part on the one or more first parameters, the one or more second parameters, one or more third parameters from a downlink control message of the semi-persistently scheduled downlink control messages, or any combination thereof.

29. The method of claim 28, further comprising:
outputting the downlink control message of the semi-persistently scheduled downlink control messages based at least in part on the one or more first parameters, the one or more second parameters, or both, wherein the downlink control message comprises the one or more third parameters associated with reception of the downlink data message.

30. The method of claim 29, wherein the downlink control message is output in a control resource set (CORESET), a search space, or both.
